(19) United States
(12) Patent Application Publication
(10) Pub. No.: US 2006/0252912 A1
(43) Pub. Date: Nov. 9, 2006

(54) Process for preparing polyoxymethylene homo- and copolymers and apparatus suitable for this purpose

(75) Inventors: Michael Hoffmockel, Niedernhausen (DE); Matthias Kramer, Frankfurt (DE); Karl-Friedrich Muck, Wiesbaden (DE); Horst Roschert, Ober-Hilbersheim (DE)

Correspondence Address: Connolly Bove Lodge & Hutz LLP, 1007 North Orange Street, P.O. Box 2207, Wilmington, DE, 19899, US

(73) Assignee: TICONA GmbH, Kelsterbach (DE)

(21) Appl. No.: 11/405,140

(22) Filed: Apr. 17, 2006

Related U.S. Application Data
(60) Provisional application No. 60/672,183, filed on Apr. 15, 2005.

(51) Int. Cl. C08G 65/34

(52) U.S. Cl. 528/425

(57) ABSTRACT

Process for preparing polyoxymethylene homo- and copolymers and apparatus suitable for this purpose An apparatus is described for preparing polyoxymethylene homo- and copolymers. This has the following elements:
A) reactor (1) encompassing a polymerization zone (2) and a deactivation zone (3) directly downstream thereof for polymerizing and deactivating polyoxymethylene homo- and copolymers in a homogeneous phase in a manner known per se,
B) depressurizing assembly (4), which, if appropriate, has a metering apparatus (5) for additives for the polymer,
C) pelletizer (6),
D) extraction apparatus (7), and
E) if appropriate, a drying apparatus (8). Use of the apparatus and of the polymerization process carried out therein can achieve particularly low residual monomer contents in a simple manner which saves energy.

### RELATED APPLICATIONS

This application claims benefit under 35 U.S.C. 119 (e) to U.S. Provisional application Ser. No. 60/672,183 filed Apr. 15, 2006 which is incorporated by reference in its entirety for all useful purposes.

The present invention relates to an improved process for preparing polyoxymethylene homo- and copolymers in a homogeneous phase, and also to an apparatus particularly suitable for this purpose.

The preparation of polyoxymethylenes is known per se. The polymerization reaction can be carried out either in bulk or else in solution, and also at atmospheric pressure or under pressure.

Numerous processes for preparing oxymethylene homo- or copolymers are known. Many publications describe the continuous polymerization of the monomers on an industrial scale, examples being U.S. Pat. No. 3,027,352, U.S. Pat. No. 3,803,094, DE-A-1,161,421, DE-A-1,495,228, DE-A-1,720,358, and DE-A-3,018,898. Polymerization reactors described are, inter alia, kneaders, extruders, rolls, or belts.

A feature common to these processes is a phase transition from gaseous or liquid monomers to the semicrystalline solid polymer, taking place during the polymerization reaction. This leads to problems in dissipating the heat evolved during polymerization and crystallization, and therefore causes conversion losses.

There have also been previous descriptions of processes in which the polymer is prepared in a homogeneous phase. EP-A-080,656 describes a process for continuous bulk polymerization of trioxane in a homogeneous liquid phase at temperatures above 135° C. Advantages mentioned for this process are, inter alia, simple operation of the process, very low energy cost, and polymers with consistent product quality.

EP-A-638,599 and DE-A-44 23 617 describe improvements in the homogeneous-phase polymerization process via simpler conduct of the process. Here, there is a simple transition from the polymerization reactor into a deactivation reactor, without separator. Between polymerization zone and deactivation zone there is an uninterrupted transition which is defined only via the addition of the deactivator. Another improvement consists in removing the unstable chain ends in the presence of residual monomers. It is possible here to lower the content of the unstable chain ends as far as about 0.1 percent by weight. However, when the product is worked up by means of a devolatilizing assembly, contaminants remain in the products prepared by this polymerization process.

EP-A-699,695 proposes improving the polymerization process described above. Here, the unstable chain ends are removed to a level of from 0.01 to 1% in the presence of residual monomers, and then the product is freed from most of the residual monomers at the reactor outlet via depressurization in a pelletizer, and the remaining residual monomers, together with the contaminants dissolved in the product, are removed via extraction with solvents, and the product is pelletized after drying and stabilization.

WO-A-01/58,974 describes another variant of the homogeneous-phase polymerization reaction. In this, the product melt is, if appropriate, deactivated, and is discharged, cooled, and pelletized at an elevated pressure and in the presence of a liquid solvent. This process reduces susceptibility to foaming during devolatilization, and minimizes production of fines during pelletization.

### SUMMARY OF THE INVENTION

There is a continuing need for polymerization methods and processing methods which are more advantageous, in order to counter the cost pressure which is encountered on all sides.

It is an object of the present invention to provide a simple process which can prepare oxymethylene homo- or copolymers in the homogeneous phase and which is energetically advantageous, and which permits efficient reduction of residual monomer content.

Another object of the present invention is provision of a process which can prepare oxymethylene homo- or copolymers in a homogeneous phase and which uses simple means to permit the production of stabilized polyoxymethylene mixtures in an energetically advantageous manner.

Surprisingly, it has now been found that a combination of various steps of a process in a prescribed sequence can give particularly advantageous energetic operation of the process. Firstly, the content of residual monomers is reduced here, utilizing the temperature of the polymer melt, and secondly remaining contaminants are efficiently eliminated in a downstream extraction stage.

It has also been found that, in one apparatus, it is possible not only to reduce the content of residual monomers but also to incorporate a stabilizer into the polymer.

### BRIEF DESCRIPTION OF THE FIGURES

FIG. 1 is a diagram of an inventive apparatus.

### DETAILED DESCRIPTION OF THE INVENTION

The present invention provides a process for preparing polyoxymethylene homo- and copolymers, encompassing the measures of:
i) polymerizing at least one monomer which forms —CH₂—O— units and, if appropriate, polymerizing one or more comonomers and at least one initiator in a homogeneous phase in a polymerization zone in a manner known per se,
ii) taking the polymer prepared in step i) and removing its unstable chain ends and/or capping its end groups, at temperatures above its melting point, and deactivating the initiator in a manner known per se via addition of deactivators in a deactivation zone immediately downstream of the polymerization zone,
iii) transferring the polymer melt into a depressurization zone,
iv) removing the residual monomers from the polymer melt via application of a reduced pressure to the depressurization zone,
v) pelletization of the polymer,
vi) extraction of remaining residual monomers and/or of oligomers and of other contaminants from the polymer, and
vii) if appropriate, drying the polymer.

Step i) involves a polymerization reaction known per se in a homogeneous phase.

To this end, a monomer which forms —CH₂—O— units, or a mixture of different monomers, is (co)polymerized with conventional initiators and, if appropriate, with regulators, at a temperature above the melting point of the resultant homo- or copolymer at pressures of up to 2000 bar.

To prepare the polyoxymethylene homo- or copolymers, a monomer which forms —CH₂—O— units, or a mixture of different monomers, is reacted in the manner described above.

The polyoxymethylene homo- or copolymers generally involve unbranched linear polymers which generally contain at least 50 mol %, preferably at least 80 mol %, in particular at least 90 mol %, of oxymethylene units (—CH₂—O—). Small amounts of branching agents can be used if desired. The amount of branching agents is usually not more than 1% by weight, based on the total amount of monomer used for preparing the polyoxymethylene homo- or copolymers, preferably not more than 0.3% by weight.

The molecular weights of these polymers can vary widely. These polymers typically have structural repeat units of the formula —(CH₂—O—)ₓ, where x is in the range from 100 to 10 000, preferably from 300 to 3000.

The expression polyoxymethylene radicals here encompasses not only radicals derived from homopolymers of formaldehyde or of its cyclic oligomers, for example of trioxane or of tetroxane, but also radicals derived from copolymeric components.

Polyoxymethylene copolymers derive from formaldehyde or from its cyclic oligomers, in particular from trioxane, and from cyclic ethers, from aldehydes, such as glyoxylic ester, from cyclic acetals, which can, if appropriate, have substitution, and/or from linear oligo- or polyacetals.

Preferred cyclic ethers or acetals are those of the formula 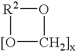
where x is 0 or 1 and R² is a C₂-C₄-alkylene group which, if appropriate, has substitution by one or more C₁-C₄-alkyl groups, by C₁-C₄-alkoxy groups, and/or by halogen atoms, preferably by chlorine atoms.

Merely by way of example, mention may be made of ethylene oxide, propylene 1,2-oxide, butylene 1,2-oxide, butylene 1,3-oxide, 1,3-dioxane, 1,3-dioxolane, 1,3-dioxepan, and 1,3,6-trioxocane as cyclic ethers, and also of linear oligo- or polyformals, such as polydioxolane or polydioxepan, as comonomers.

The materials can also involve block copolymers which have not only polyoxymethylene blocks but also have structural units derived from hydroxy-terminated polymers. Preferred block copolymers derive from polyoxymethylene homopolymer blocks or from polyoxymethylene copolymer blocks and from polyalkylene glycol blocks or from hydroxy-terminated polybutadiene blocks.

These copolymers are described by way of example in EP-A-1,418,190.

It is preferable to prepare polyoxymethylene copolymers which have polyoxymethylene radicals having from 99.9 to 90 mol % of structural repeat units of the formula —(CH₂—O—)ₓ, preferably derived from trioxane, and from 0.1 to 10 mol % of structural repeat units derived from one of the abovementioned comonomers.

It is particularly preferable to prepare polyoxymethylene copolymers which have polyoxymethylene blocks having from 99.9 to 90 mol % of structural repeat units of the formula —(CH₂—O—)ₓ, preferably derived from trioxane, and from 0.1 to 10 mol % of structural repeat units of the formula
—(CH₂—CH₂—O—)_{z}
where z is a whole number which is at least 1.

Other polyoxymethylene copolymers that can be prepared are polymers having structural repeat units which by way of example are prepared via reaction of trioxane and of one of the cyclic ethers or acetals described above, and using a third monomer, preferably a bifunctional dioxolane, a bifunctional dioxane, or a bifunctional epoxide. Examples of a bifunctional epoxide are compounds of the formula 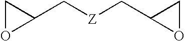
where Z is a chemical bond, —O— or —O—R¹—O— (R¹=C₂- to C₈-alkylene or C₂-C₈-cycloalkylene).

Preferred monomers of this type are ethylene diglycide, diglycidyl ether, and diethers composed of glycidyl compounds and formaldehyde in a molar ratio of 2:1, and also diethers composed of 2 mol of glycidyl compound and 1 mol of an aliphatic diol having from 2 to 8 carbon atoms, e.g. the diglycidyl ether of ethylene glycol, 1,4-butanediol, 1,3-butanediol, 1,3-cyclobutanediol, 1,2-propanediol, 1,4-cyclohexanediol, and also diglycerol diformal, to mention just a few examples.

Processes for preparing the POM homo- and copolymers described above are known to the person skilled in the art and are described in the literature.

The polymerization mixture is in liquid form during the homogeneous-phase polymerization reaction, or is in this condition for a period during which the polymerization reaction takes place.

The molecular weight of the resultant (co)polymers can, if appropriate, be adjusted via use of the regulators known per se for preparing polyoxymethylenes.

Examples of regulators are acetals, such as methylal, ethylal, or butylal, or other dihydric alcohols of the formula HO—R¹—OH, in which R¹ is a divalent aliphatic radical, and also very small amounts of water. These can function as chain-transfer agents. The amounts usually used of the regulators are up to 50 000 ppm, preferably from 100 to 3000 ppm.

Initiators which can be used are the cationic initiators usually used in preparing oxymethylene homopolymers or oxymethylene copolymers. Examples of these are proton acids, such as fluorinated or chlorinated alkyl- and arylsulfonic acids, e.g. trifluoromethanesulfonic acid, trifluoromethanesulfonic anhydride, or heteropolyacids, such as hexatungstatophosphoric acid or hexamolybdatophosphoric acid, or Lewis acids, e.g. tin tetrachloride, arsenic pentafluoride, phosphorus pentafluoride and boron trifluoride, and also their complex compounds and salt-like compounds, e.g. boron trifluoride etherates and triphenylmethyl hexafluorophosphate.

The amounts usually used of the initiators are from 0.01 to 1000 ppm, preferably from 0.03 to 100 ppm, based on the monomer (mixture).

According to the invention, selection of pressure and temperature in the polymerization zone is to be such that monomers and polymer are present in homogeneous distribution, preferably entirely dissolved in one another. Reaction pressures and reaction temperatures are to be suitably selected in order to ensure that this occurs.

Typical polymerization temperatures vary in the range from 130° C. to 170° C.

Typical deactivation temperatures vary in the range from 150° C. to 250° C., preferably from 170° C. to 200° C.

Typical polymerization pressures and deactivation pressures vary in the range from 10 to 2000 bar, preferably from 15 to 200 bar.

Polymerization and deactivation can take place in the reactors known for preparing POM homo- or copolymers. Those typically used are kneaders, extruders, or preferably tubular reactors designed with static mixers, these being of temperature-controllable and pressure-tight design.

Steps i) and ii) are preferably conducted at elevated temperatures and pressures.

Steps i) and ii) are particularly preferably conducted in one reactor, in particular in a tubular reactor provided with static mixers.

The polymerization time can vary widely and typically varies in the range from 0.1 to 20 minutes. The polymerization time is preferably from 0.4 to 5 minutes.

After the polymerization reaction, the hot polymer melt is deactivated in a manner known per se. This is achieved via addition, to the polymer melt, of deactivators for the initiator, directly after the polymerization reaction. This step can be carried out as described in EP-A-699,695 or in EP-A-638,599. The known basic compounds can be used as deactivators, examples being sodium carbonate, disodium hydrogen phosphate, or tertiary amines.

Polymerization and deactivation are preferably carried out in one reactor, for example a tubular reactor, where between polymerization zone and deactivation zone there is an uninterrupted transition, defined only via the addition of the deactivator. However, the two steps of the process can also be undertaken in separate assemblies.

The stabilization of the resultant crude (co)polymer proceeds in parallel with the deactivation of the initiators. In the case of the homopolymers, this can take place via capping of end groups, for example via etherification or esterification with suitable capping agents, for example with acetic acid derivatives, e.g. with acetic anhydride, and in the case of the copolymers can take place via controlled degradation of the polymer chains produced until a stabilizing monomer unit is reached. These measures are known per se.

After the deactivation and stabilization of the polymer melt, it is transferred into a depressurization zone for removal of the residual monomers, and the residual monomers are removed via application of a reduced pressure.

The depressurization zone is formed by a space which is filled by the hot polymer melt. Most of the remaining residual monomers are driven off from the polymer melt via application of a subatmospheric pressure, preferably a pressure of less than 500 mbar, in particular of less than 200 mbar, utilizing the temperature of the polymer melt. This step of the process can be carried out in a separate portion of the tubular reactor, and preferably in an extruder. However, it is also possible to use other assemblies, e.g. a flash chamber.

For this purpose, it is preferable that, after step ii), the polymer melt is transferred, with maintenance of pressure, into an extruder in which depressurization and suction-removal of the residual monomers take place.

It is particularly preferable to use a twin-screw extruder.

If appropriate, stabilizers and processing aids (hereinafter also termed additives) can be incorporated into the polymer before it leaves the depressurization zone. The selection of these additives is to be such that they are not in turn removed from the polymer via the subsequent extraction stage.

In one preferred variant of the inventive process, after removal of the residual monomers, a mixture of additives is fed into the extruder and is incorporated into the hot polyoxymethylene homo- or copolymer.

In this embodiment of the inventive process, the selection of the mixture of additives is such that it comprises only components which are resistant to the subsequent extraction stage, these preferably being insoluble in hot water.

For the purposes of the present description, the expression insoluble in hot water means that the solubility of a compound in hot water is so low that at least 95% by weight thereof remains in the mixture under the selected extraction conditions.

Components that can be used in the mixture of additives are the compounds usually used for stabilizing and/or modifying polyoxymethylenes.

By way of example, these involve antioxidants, acid scavengers, formaldehyde scavengers, UV stabilizers, or heat stabilizers. The mixture of additives can also comprise processing aids, such as coupling agents, lubricants, nucleating agents, mold-release agents, fillers, reinforcing materials, or antistatic agents, and also additives which give the molding composition a desired property, e.g. dyes and/or pigments, and/or impact modifiers, and/or additives conferring electrical conductivity; and mixtures of these additives, but without restricting scope to the examples mentioned.

Once the residual monomers have been driven off in the depressurizing zone and any additives have been added, the polymer is pelletized, and the remaining residual monomers and/or oligomers and/or other contaminants are removed from the polymer in an extraction stage.

Pelletization and extraction can take place in assemblies known per se.

Examples of pelletizers are strand pelletizers, water-cooled die-face pelletizers, and underwater pelletizers.

An example of an extraction apparatus is a counter-current washer.

Downstream of the extraction stage there is preferably a drying process, in order to free the pellets from adhering residues of extractant.

The polymer can then, if appropriate, be provided with additives in a manner known per se. In this stage of the process it is also possible to add additives which would be in turn dissolved out from the polymer in the extraction stage.

The extraction process can be carried out with any desired extractants for the removal of oligomers and/or of residual monomers. A hot water treatment is preferred.

The hot water treatment preferably takes the form of a counter-current wash, in particular under pressure and at temperatures above 100° C.

Typical treatment temperatures vary in the range from 100 to 170° C., preferably from 110 to 150° C. and particularly preferably from 120 to 135° C.

The treatment pressures typically vary from 1 to 5 bar above the vapor pressure of the extraction medium at the selected extraction temperature.

In another preferred variant of the inventive process, the melt of the polyoxymethylene homo- or copolymer is solidified and pelletized after leaving the depressurization zone, without addition of a mixture of additives to the polymer in the depressurization zone, and is then subjected to a hot water extraction process.

In this embodiment, after the hot water treatment, the pellets are compounded with a mixture of additives for the polyoxymethylene homo- or copolymer, preferably via melting of the pellets in an extruder and via mixing to incorporate the mixture of additives in the extruder. The extrudate is then again pelletized.

In this embodiment of the inventive process, it is possible to use mixtures of additives with components soluble in hot water.

The polyoxymethylene homo- and copolymers prepared according to the invention can be further processed in a manner known per se via molding processes, such as blow molding, injection molding, or extrusion, to give moldings.

The invention also provides an apparatus for carrying out the process described above. This apparatus encompasses the following elements in the following sequence:
A) reactor (1) encompassing a polymerization zone (2) and a deactivation zone (3) directly downstream thereof for polymerizing and deactivating polyoxymethylene homo- and copolymers in a homogeneous phase in a manner known per se,
B) depressurizing assembly (4), which, if appropriate, has a metering apparatus (5) for stabilizers for the polymer,
C) pelletizer (6),
D) extraction apparatus (7),
E) if appropriate, a drying apparatus (8), and
F) if appropriate, an apparatus (17) for incorporating stabilizers for the polymer.

The reactor (1) preferably involves a tubular reactor, equipped with static mixers.

The depressurizing assembly (4) preferably involves an extruder, preferably a twin-screw extruder.

The extraction apparatus (7) preferably involves a counter-current washer.

The apparatus (17) preferably involves an extruder, very particularly preferably a twin-screw extruder.

The figures below describe two embodiments of the inventive apparatus and of the inventive process, by way of example.

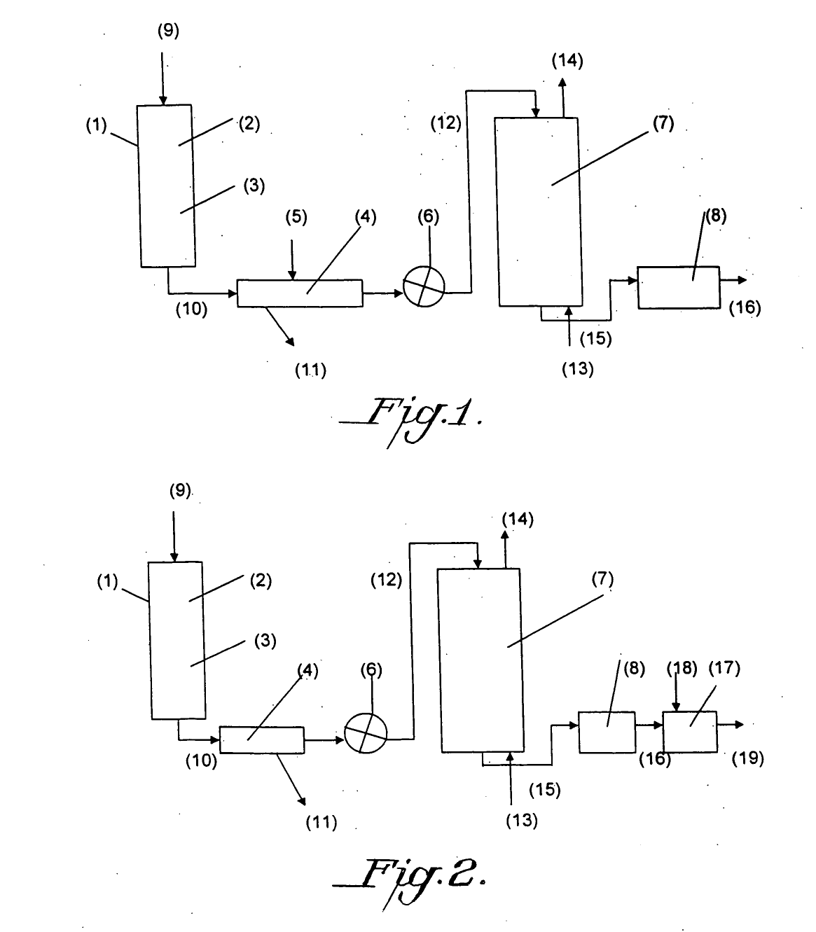

FIG. 1 is a diagram of an inventive apparatus composed of reactor (1), depressurizing assembly formed from an extruder (4), which has a metering apparatus (5) for additives for the polymer, of a pelletizer (6), of an extraction apparatus (7), and of a drying apparatus (8).

Reactor (1) is composed of polymerization zone (2) and of a deactivation zone (3) directly downstream thereof, beginning at the site of feed of the deactivator by way of line (17). The reactants are introduced via line (9) into the reactor (1). The polymer melt leaving reactor (1) by way of line (10) is freed from residual monomers in the extruder (4) via suction-removal of the same by way of line (11), and by way of metering apparatus (5) additives resistant to hot water extraction are introduced into the polymer and are incorporated into the polymer in the extruder (4). The extrudate is then pelletized in the pelletizer (6), and introduced by way of line (12) into an extraction apparatus (7), where it is subjected to a counter-current hot water treatment (13, 14). The extraction-treated pellets leave the extraction apparatus (7) by way of line (15) and are dried in a drying apparatus (8), which they leave by way of line (16).

FIG. 2 is a diagram of another inventive apparatus composed of reactor (1), depressurizing assembly formed from an extruder (4), and of a pelletizer (6), of an extraction apparatus (7), of a drying apparatus (8), and of another extruder (17).

Reactor (1) is composed of polymerization zone (2) and of a deactivation zone (3) directly downstream thereof, beginning at the site of feed of the deactivator by way of line (20). The reactants are introduced into the reactor (1) via line (9). The polymer melt leaving reactor (1) by way of line (10) is freed from residual monomers in the extruder (4) via suction-removal of the same by way of line (11). The extrudate is then pelletized in the pelletizer (6), and introduced by way of line (12) into an extraction apparatus (7), where it is subjected to a counter-current hot water treatment (13, 14). The extraction-treated pellets leave the extraction apparatus (7) by way of line (15), and are dried in a drying apparatus (8), and are introduced by way of line (16) into an extruder (17). By way of metering apparatus (18), additives are introduced into the polymer, and are incorporated into the polymer in the extruder (17). The polymer incorporating additives leaves extruder (17) by way of line (19).

All the references described above are incorporated by reference in their entirety for all useful purposes.

1. A process for preparing polyoxymethylene homo- and copolymers, encompassing the measures of:
i) polymerizing at least one monomer which forms —CH₂—O— units and optionally polymerizing one or more comonomers and at least one initiator in a homogeneous phase in a polymerization zone,
ii) taking the polymer prepared in step i) and removing its unstable chain ends and/or capping its end groups, at temperatures above its melting point, and deactivating the initiator via addition of deactivators in a deactivation zone immediately downstream of the polymerization zone,
iii) transferring the polymer melt into a depressurization zone,
iv) removing the residual monomers from the polymer melt via application of a reduced pressure to the depressurization zone,
v) pelletization of the polymer,
vi) extraction of remaining residual monomers and/or of oligomers and of other contaminants from the polymer, and
vii) optionally drying the polymer.

2. The process as claimed in claim 1, wherein steps i) and ii) are carried out in a tubular reactor equipped with static mixers.

3. The process as claimed in claim 1, wherein the depressurization is carried out in an extruder.

4. The process as claimed in claim 3, wherein a twin-screw extruder is used as extruder.

5. The process as claimed in claim 4, wherein, after the removal of the residual monomers, a mixture of additives is fed into the extruder, and is incorporated into the hot polymer in the extruder, the selection of the mixture of additives being such that it is not extractable in step vii).

6. The process as claimed in claim 5, wherein the mixture of additives comprises only components which are not soluble in hot water.

7. The process as claimed in claim 1, wherein the extraction process is a hot water treatment for removal of water-soluble oligomers and/or residual monomers.

8. The process as claimed in claim 7, wherein the hot water treatment takes the form of a counter-current wash under pressure and at temperatures above 100° C.

9. The process as claimed in claim 1, wherein the pellets are compounded, after extraction and drying, with a mixture of additives for the polyoxymethylene homo- or copolymer, via melting of the pellets in an extruder and via mixing to incorporate the mixture of additives into the extruder, and wherein the extrudate is then pelletized.

10. The process as claimed in claim 9, wherein the mixture of additives comprises components soluble in hot water.

11. An apparatus for preparing polyoxymethylene homo- and copolymers, encompassing the following elements in the following sequence:
A) reactor encompassing a polymerization zone and a deactivation zone directly downstream thereof for polymerizing and deactivating polyoxymethylene homo- and copolymers in a homogeneous phase,
B) depressurizing assembly and said assembly optionally has a metering apparatus for stabilizers for the polymer,
C) pelletizer,
D) extraction apparatus,
E) if appropriate, a drying apparatus (8), and
F) optionally an apparatus for incorporating stabilizers for the polymer.

12. The apparatus as claimed in claim 11, wherein reactor is a tubular reactor equipped with static mixers.

13. The apparatus as claimed in claim 11, wherein the depressurizing assembly is an extruder.

14. The apparatus as claimed in claim 11, wherein the extraction apparatus is a counter-current washer.

15. The apparatus as claimed in claim 11, wherein the apparatus for incorporating stabilizers for the polymer is an extruder.

16. The apparatus as claimed in claim 11, wherein the apparatus for incorporating stabilizers for the polymer is a twin-screw extruder.

17. The apparatus as claimed in claim 11, wherein the depressurizing assembly is a twin-screw extruder.
